(19) United States
(12) Patent Application Publication
(10) Pub. No.: US 2026/0115882 A1
(43) Pub. Date: Apr. 30, 2026

(54) ROTARY TOOL

(71) Applicant: MILWAUKEE ELECTRIC TOOL CORPORATION, Brookfield, WI (US)

(72) Inventors: Kushagra Dixit, Milwaukee, WI (US); Noah P. Seiler, Milwaukee, WI (US); Jonathon R. Gasteiner, Brookfield, WI (US)

(21) Appl. No.: 18/932,999

(22) Filed: Oct. 31, 2024

(51) Int. Cl. B25F 5/02; B25F 5/00; F21V 23/00; F21V 33/00

(52) U.S. Cl. CPC B25F 5/02; B25F 5/001; F21V 23/002; F21V 33/0084

(57) ABSTRACT

A power tool including a housing having a first end and a second end; a motor disposed within the housing, the motor including a drive shaft rotatably driven by the motor and defining a motor axis; a bit holder positioned adjacent a distal end of the housing and driven by rotation of the drive shaft; a light source positioned on the first end of the housing; control electronics disposed adjacent to the motor, the control electronics including a printed circuit board defining a control electronics axis that is oblique to the motor axis; and a light source wire electrically coupling the light source with the control electronics, wherein the motor is positioned between the light source and the control electronics such that the light source wire extends axially across the motor along a top side of an interior of the housing to couple the light source with the control electronics.

### FIELD

Embodiments described herein relate to battery pack powered power tools and power tool devices.

### BACKGROUND

Rotary tools typically include a housing, a power supply positioned within the housing, a motor positioned within the housing, and a bit holder disposed on a distal end of the housing. Rotary tools may accept a desired bit within the bit holder and may be used to perform cuts, sand or polish objects, and/or drill holes, among other things.

### SUMMARY

In one aspect, a rotary tool includes a housing having a first end and a second end; a motor disposed within the housing, the motor including a drive shaft rotatably driven by the motor and defining a motor axis; a bit holder positioned adjacent a distal end of the housing and driven by rotation of the drive shaft; a light source positioned on the first end of the housing, the light source configured to emit light in a direction toward the bit holder; control electronics disposed adjacent to the motor within the housing, the control electronics including a printed circuit board defining a control electronics axis that is oblique to the motor axis; and a light source wire electrically coupling the light source with the control electronics, wherein the motor is positioned between the light source and the control electronics such that the light source wire extends axially across the motor along a top side of an interior of the housing to couple the light source with the control electronics.

In another aspect, a rotary tool includes a housing having a first end and a second end; a motor disposed within the housing, the motor including a drive shaft rotatably driven by the motor and defining a motor axis; a spindle positioned within the housing and driven by the drive shaft of the motor; a bit holder positioned adjacent a distal end of the housing and driven by rotation of the drive shaft; a spindle lock assembly positioned between the motor and the first end of the housing, the spindle lock assembly configured to selective prevent rotation of the spindle; a light source supported on the first end of the housing and configured to emit light in a direction toward the bit holder; a printed circuit board (PCB) supported within the housing, the printed circuit board positioned on an opposite side of the motor as the spindle lock; and a light source wire electrically coupling the light source with the control electronics, wherein the light source wire is routed around the spindle lock assembly and over the top of the motor to couple the light source with the control electronics.

In yet another aspect, a rotary tool includes a clamshell housing having a first side and a second side coupled via screws extending through a first screw boss and a second screw boss, the clamshell housing having a first end and a second end; a motor disposed within the housing, the motor including a drive shaft rotatably driven by the motor and defining a motor axis; a spindle positioned within the housing and driven by the drive shaft of the motor, the spindle extending through the motor and supported on a first end by a bearing disposed within a bearing pocket; a bit holder positioned adjacent a distal end of the housing and driven by rotation of the spindle; a light source positioned on the first end of the clamshell housing and configured to emit light in a direction toward the bit holder; a printed circuit board (PCB) disposed within the housing; a light source wire electrically coupling the light source with the printed circuit board, the light source wire routed around the outside of the first crew boss; and a motor wire coupling the motor to the printed circuit board, the motor wire routed around the outside of the second screw boss.

Other features and aspects of the disclosure will become apparent by consideration of the following detailed description and accompanying drawings.

### BRIEF DESCRIPTION OF THE DRAWINGS

FIG. 1A is a perspective view of a rotary tool according to one embodiment of the disclosure.

FIG. 1B is a perspective view of the rotary tool of FIG. 1A with a collet head removed.

FIG. 2A is a front perspective view of a collet head of FIG. 1A.

FIG. 2B is a rear perspective view of a collet head of FIG. 1A.

FIG. 3 is a perspective view of a body of the rotary tool of FIG. 1A.

FIG. 4 is a cross-sectional side view of the rotary tool of FIG. 1A.

FIG. 5 is a cross-sectional side view of the rotary tool of FIG. 1A.

FIG. 6 is a perspective cross-sectional view of the rotary tool of FIG. 1A.

FIG. 7 is a schematic diagram of electronic circuitry of the rotary tool of FIG. 1A.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

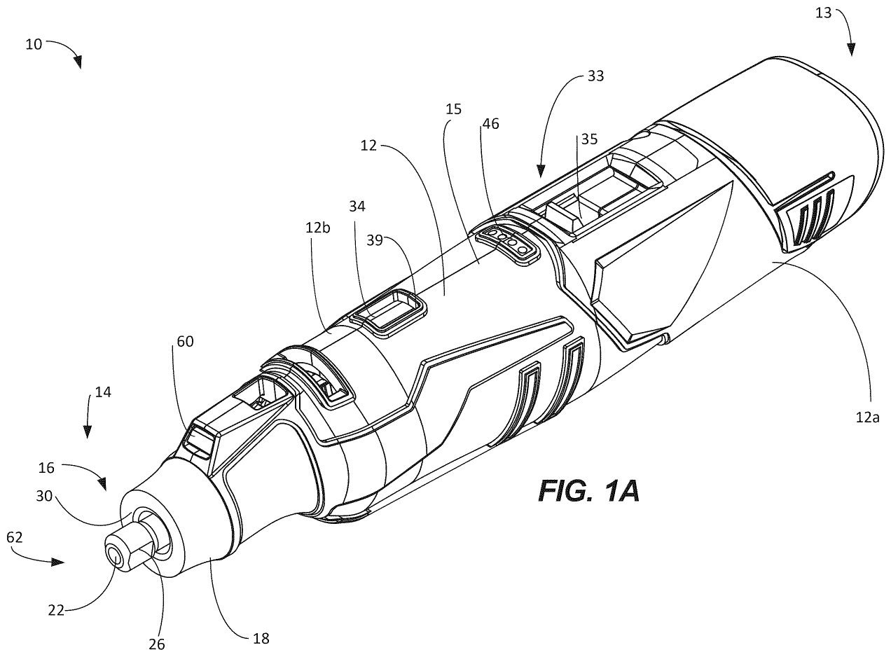

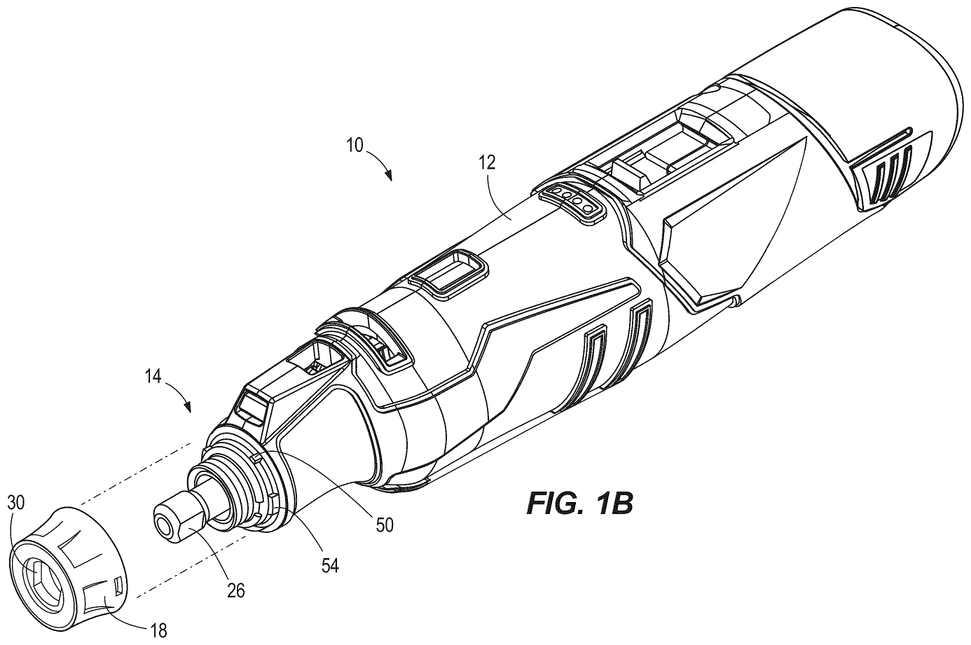

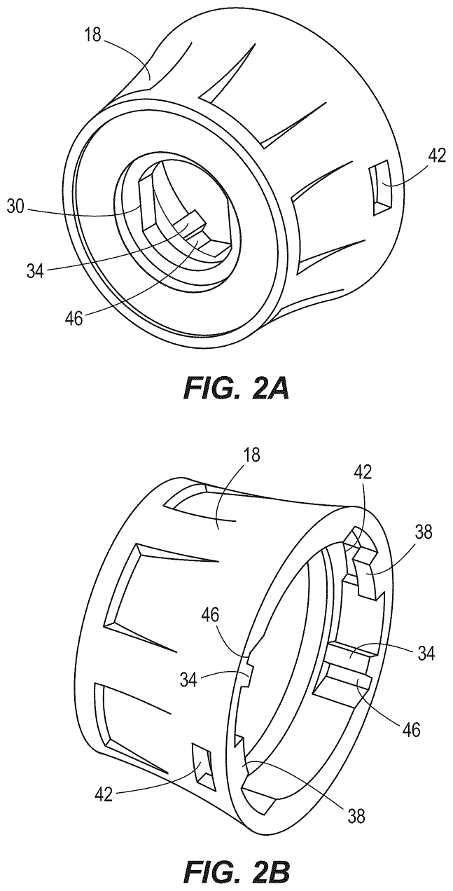

FIGS. 1A-2B illustrate a rotary tool 10 according to one embodiment. The rotary tool 10 may be used for engraving, fine detail sanding, and polishing. The rotary tool 10 may include a tapered cylindrical body 12, or housing. The body 12 may be a clamshell housing including a first side 12a and a second side 12b coupled via a screw supported by a screw boss 20 extending through the first side 12a and the second side 12b. The body 12 includes a first end 14, a second end 13, and a handle 15 extending between the second end 13 and the first end 14. The first end 14 may be further understood as a distal working end configured to contact a workpiece. The second end 13 may be further understood as a proximal end. The handle 15 may be configured to be grasped by a user. In the embodiment described herein, the rotary tool 10 may be an entirely handheld unit which houses a battery (not shown) and a motor 17 within the body 12 of the rotary tool 10. More specifically, the rotary tool 10 may have a compact size of less than one pound and an ergonomic handle 15 configured for comfort and control during usage. In other embodiments, the rotary tool 10 may be connected to a remote base by a flexible cord. In such an embodiment, the base may house a battery thereby allowing the rotary tool to have a smaller profile.

The first end 14 of the rotary tool 10 may include a nose portion 16 to which a collet wrench 18 is removably attachable. The body 12 may support a drive mechanism including a bit holder assembly 62, illustrated as a collet 22 and collet nut 26, configured to support a working tool bit. The bit holder assembly 62 may removably accept any one of a variety of bits (various tool accessories, such as sanders, polishers, engravers), and retain the bit during use of the rotary tool 10. Portions of the bit holder assembly 62 may be caused to rotate and, thus, rotate the bit disposed therein for performing an operation (e.g., a clearing operation, a cutting operation, a grinding operation, and/or the like). The collet wrench 18 may be attachable to the body 12 to be stowed away when the rotary tool 10 is in use and may be releasable from the body 12 to tighten or untighten the collet nut 26. Therefore, the rotary tool 10 may not require an auxiliary wrench to change working tool bits. The integrated collet wrench 18 may allow for quick accessory changes with the included collet 22 which is compatible with standard size accessories (accessories sized 1/32 inch, 1/16 inch, and 3/32 inch).

When disengaged from the body 12 of the rotary tool 10, the collet wrench 18 may be used to tighten or untighten the collet nut 26. The collet wrench 18 may include a wrench plate 30 configured to engage a surface of the collet nut 26 so that it may rotate the collet nut 26 to tighten or untighten the collet nut 26.

When not in use, the collet wrench 18 may be secured to the body 12 of the rotary tool 10 by a bayonet and detent style connection. As shown in FIGS. 2A and 2B, the bayonet and detent style connection includes a plurality of ribs and slots that enable the collet wrench to slide axially onto the body 12 and then rotate into a locked position. Specifically, the collet wrench 18 may include two tangential ribs 38 positioned opposite one another along the circumference of the collet wrench 18. The collet wrench 18 may also include two axial ribs 34 positioned opposite one another and adjacent the two tangential ribs 38. A tangential slot 42 may be positioned adjacent each tangential rib 38, and an axial recess 46 is positioned adjacent each axial rib 34.

The nose portion 14 of the body 12 may include two ribs 50 positioned opposite one another, which correspond to the axial ribs 34 and axial recesses 46 of the collet wrench 18. The nose portion 14 of the body 12 may also include two tangential ribs 54 positioned opposite one another, which correspond to the tangential ribs 38 and tangential slots 42 of the collet wrench 18. Either one of the tangential ribs 54 on the body 12 may be received in either one of the tangential slots of the collet wrench 18. Accordingly, the collet wrench 18 may be secured to the body 12 in two different rotational positions, which are 180 degrees relative to one another.

When the collet wrench 18 is attached to the body 12, an interference fit between the tangential rib 54 of the body 12 and the tangential slot 42 of the collet wrench 18 may prevent axial and rotational movement of the collet wrench 18 relative to the body 12. In particular, the tangential rib 54 may engage with the tangential slot 42 similar to a detent to selectively lock the collet wrench 18 to the body 12 of the rotary tool. Alternatively, the collet wrench 18 may be stowed away by threading the collet wrench 18 onto the end of the rotary tool 10. In this embodiment, the collet wrench 18 is unthreaded from the end of the rotary tool 10 in order to adjust the collet 22.

To tighten or untighten the collet nut 26, a user first must disengage the collet wrench 18 from the body 12. This is accomplished by rotating the collet wrench 18 relative to the body 12 to remove the tangential rib 54 from the tangential slot 42. Next, the collet wrench 18 is moved axially away from the body 12 to disengage from the body 12. The axial ribs 34, 50 and the axial recesses 46 guide movement of the collet wrench 18 as the collet wrench 18 is separated from or attached to the body 12. In other words, the axial ribs 34, 50 and the axial recesses 46 ensure rotational alignment of the tangential ribs 38, 54, and tangential slots 42.

The first end 14 of the rotary tool 10 may additionally include a light source (e.g., a light emitting diode) 60 configured to emit light in a direction toward the first end 14. The light source 60 may be positioned within a retention recess 61 disposed on the first end 14 of the rotary tool 10 to illuminate a work surface during use. In some embodiments, the tool 10 may include a transparent region and the light source may be piped through the transparent region during use. In the present embodiment, the light source may be disposed on an outer portion of the rotary tool 10.

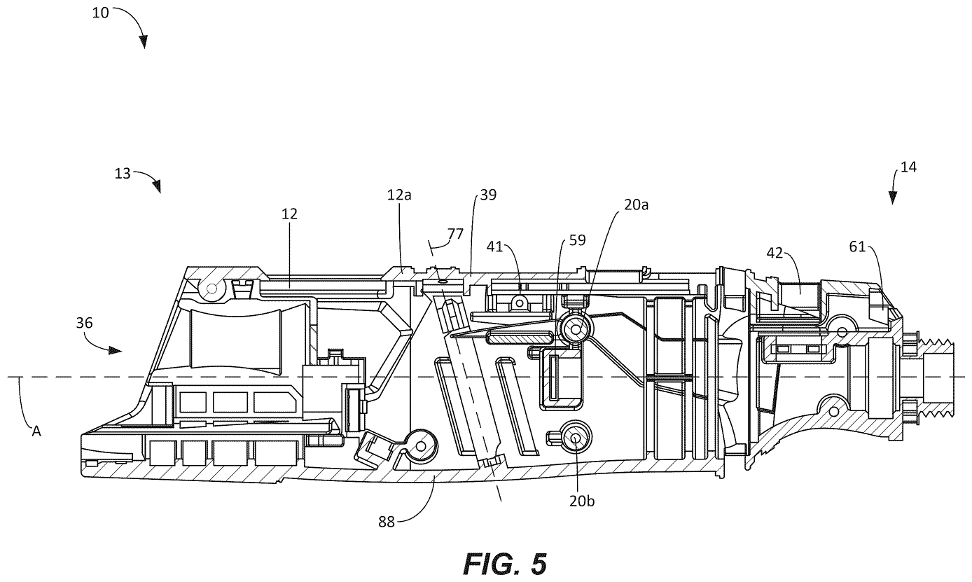

The handle 15 of the rotary tool 10 may include a user interface 33 on a top side 39 of the body 12. The user interface 33 may include a power actuator 34 and a variable speed control actuator 35. The power actuator 34 may be configured to turn the rotary tool 10 on and off while the variable speed control actuator 35 may be configured to adjust the rotational speed of the motor 17. The power actuator 34 may be movably coupled with the body 12 and may be actuatable to power the motor 17, e.g., to electrically couple a battery pack and the motor 17 to run the motor 17. The power actuator 34 may be a slider as shown, or in other implementations may include a trigger-style actuator, a button, a lever, a knob, etc. The power actuator 34 may include a magnet (not shown) that, when the slide switch is actuated to an ON position, is sensed by a magnetic sensor 37 (e.g., a Hall effect sensor) located within the body 12. More specifically, the magnetic sensor 37 may be disposed within a power actuator housing 41 arranged adjacent the top side 39 of the interior of the body 12 (FIG. 5). The magnetic sensor 37 may be a linear magnetic sensor that will sense a varying amount of magnetic flux based on the proximity of the magnetic sensor 37 to the magnet. When the magnetic sensor 37 senses that the magnet is in close proximity to the magnetic sensor 37, the magnetic sensor 37 may transmit a signal to a controller 54 of the power tool to wake up the controller 54.

The variable speed control actuator 35 may similarly be movably coupled with the body 12 and actuatable to adjust the operational speed of the motor 17 and thereby, the rotational speed of the tool accessory. In the illustrated embodiment, the variable speed control actuator 35 may include a speed increase button 35a and a speed decrease button 35b positioned near the first end 14 of the rotary tool 10. In other words, the variable speed control actuator 35 may be a set of two push buttons—a “+” button 35a for increasing rotational speed of the motor 17 and a “−” button 35b for decreasing rotational speed of the motor 17. More specifically, the variable speed control actuator 35 may adjust the speed between 27,500 RPM to 5,000 RPM.

Accordingly, the rotary tool 10 may include 12-speed settings to complete a wide range of cutting, grinding, sanding, and polishing applications. In other embodiments, the variable speed control actuator 35 may include a different type of actuator, such as a slidable actuator or a dial. Likewise, the variable speed control actuator 35 may be positioned elsewhere on the rotary tool 10 or, in some cases, may be positioned on the body 12.

The user interface 33 may further include a speed display 46 configured to indicate one of the twelve speed levels set by the variable speed control actuator 35. In the illustrated embodiment, the speed display 46 may be a liquid crystal display (LCD), although other embodiments may include different types of displays 46 (e.g., thin film transistor (TFT), or organic light-emitting diode (OLED)). In some embodiments, the display 46 is or forms part of an LCD capacitive sensing display 46. In yet other examples, the speed display 46 is comprised of twelve LEDs configured to light up to indicate one of the twelve speed levels.

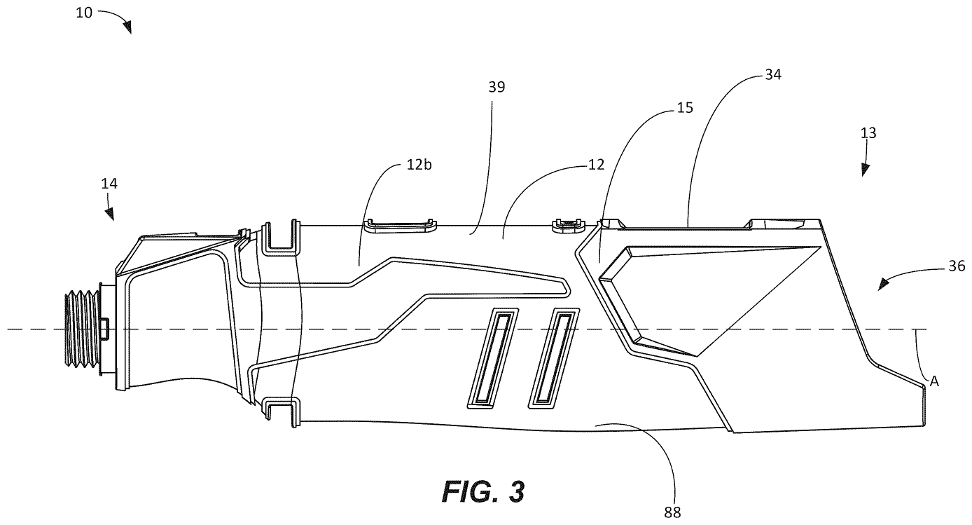

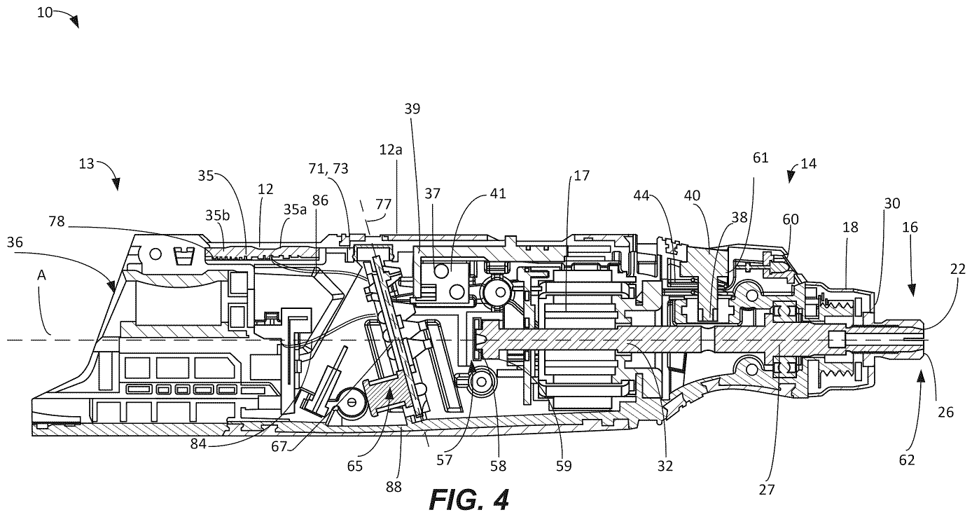

As illustrated in FIGS. 3-5, an interior of the body 12 of the rotary tool 10 may include a rotating spindle 27 driven by the motor 17, which may ultimately transfer rotational force to the bit holder assembly 62. The spindle 27 may be positioned on the first end 14 and may extend through the motor 17 such that the spindle 27 is supported on a first end 57 by a bearing 58 supported within a bearing pocket 59.

In the present embodiment, the motor 17 may be a DC brushless motor disposed within the body of the first end 14. The motor 17 may further be a variable speed or multi-speed motor. In other implementations, other suitable motors may be employed. The motor 17 in the illustrated embodiment is an electric motor driven by a battery pack, but may be powered by other power sources such as an AC power cord in other implementations. In yet other implementations, the rotary tool 10 may be pneumatically powered or powered by any other suitable power source and the motor 17 may be a pneumatic motor or other suitable type of motor. The motor 17 includes a motor drive shaft 32 extending therefrom and driven for rotation about a motor axis A. Accordingly, the spindle 27 extends along motor axis A.

The rotary tool 10 may additionally include a spindle lock assembly including a spindle lock switch 40 and a locking structure 38. The locking structure 38 is positioned adjacent the spindle 27, and the spindle lock switch 40 is at least partially positioned in a recess 42 of the body 12. The spindle lock assembly is positioned axially between the first end 14 of the body 12 and the motor 17. The spindle lock switch 40, or a portion thereof, is configured to engage or disengage from the locking structure 38 of the spindle 27 for causing the spindle 27 to respectively lock (e.g., not rotate) or unlock (e.g., rotate). In this way, the spindle 27 may be locked, for example, when the collet 22 is being released or clamped respective to the bit holder assembly 62 and/or a bit is being inserted or removed respective to the bit holder assembly 62. The spindle lock switch 40 may be slidably movable relative to the body 12 to engage with the locking structure 38 and to prevent rotation of the spindle 27. A biasing member 44 (e.g., a spring) may be disposed on or over the spindle lock switch 40, or a portion thereof, for biasing a slidable switch member of the spindle lock switch 40 towards an unlocked position, which in turn allows rotation of the spindle 27.

The rotary tool 10 may also include, among other things, control electronics 65 disposed adjacent to the motor 17 within the body 12. The control electronics 65 may include a controller or processor that controls operation of the rotary tool 10. The control electronics may include a printed circuit board (“PCB”) 67 are located and a user interface board 78 on which the speed increase button 35a and the speed decrease button 35b are located. The PCB 67 extends along a control electronics axis 77. The control electronics axis 77 may be a central longitudinal axis of the PCB 67. In the illustrated embodiment, the control electronics axis 77 intersects the motor axis A at an oblique angle. This orientation of the control electronics results space saving within the rotary tool 10 to allow for a compact design.

The PCB 67 may include a lighting element 71 (e.g., LEDs mounted to the substrate of the PCB 67) and a light output 73 (e.g., lenses, diffusers, etc.) configured to emit visible light generated by the respective lighting element 71. The lighting element 71 may include single color or multi-color (e.g., RGB, RGBW, etc.) LED. In other embodiments, other types of lighting elements 71 may be used. In the illustrated embodiment, the lighting element 71 may be mounted to an upper end of the PCB 67, and the light output 73 may be optically coupled to the lighting element by a light pipe, which transmit light from the lighting element 71 to the light output 73 (e.g., via internal reflection). The light output 73 may extend through corresponding apertures in the clamshell housing of the body adjacent the top side 39 such that the light outputs 73 are visible to a user looking down at the top side 39 of the body 12. The lighting element 71 may function as an indicator light to provide information to a user about the operation status of the rotary tool 10. For example, the lighting element 71 may provide information to a user, such as a power status, speed information, or other indications.

The second end 13 of the rotary tool 10 may include a battery receptacle 36 positioned within the main body 12 and configured to receive a battery (not shown). The battery may be removably attached to the battery receptacle 36. The battery is a power source that may be operably connected to the motor 17 for providing power thereto. In some embodiments, the battery may include one or more battery cells. For example, the battery pack may be a 12-volt battery pack and may include three (3) Lithium-ion battery cells. In other embodiments, the battery pack may include fewer or more battery cells such that the battery pack is a 14.4-volt battery pack, an 18-volt battery pack, or the like. Additionally, or alternatively, the battery cells may have chemistries other than Lithium-ion such as, for example, Nickel Cadmium, Nickel Metal-Hydride, or the like. Additionally, or alternatively, the rotary tool assembly may use a power source such as a cord providing an alternating current power supply, e.g., from a utility source such as a standard outlet, and may include a transformer as necessary.

In some embodiments, the interior of the body 12 may include a fuse and a rubber slug disposed on the second end 13.

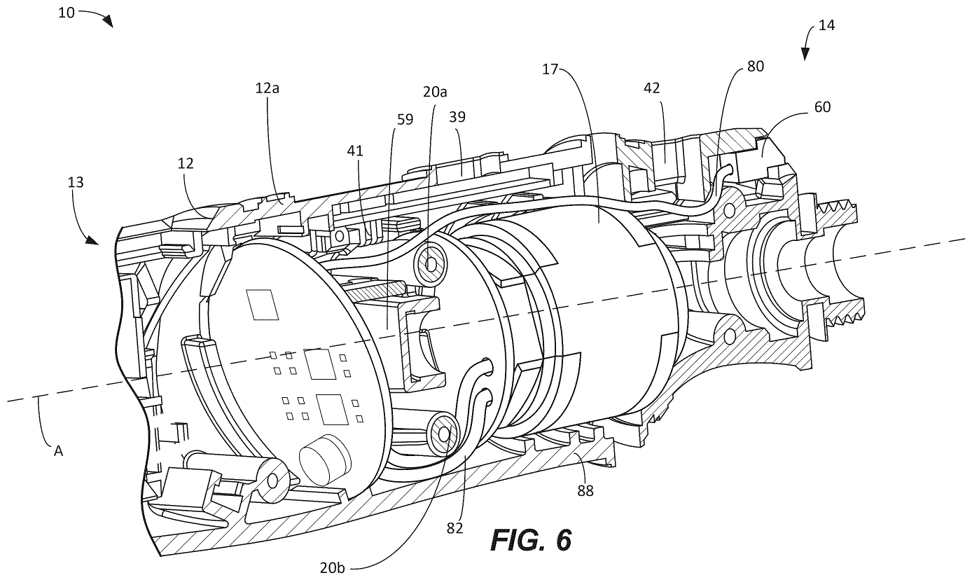

As illustrated in FIG. 6, various components within the rotary tool 10 may be operably coupled with the PCB 67 via a plurality of wires. More specifically, the light source 60 may be coupled with the PCB 67 via a light source wire 80, the motor 17 may be coupled with the PCB 67 via a plurality of motor wires 82, the battery receptacle 36 may be coupled with the PCB 67 via a battery receptacle wire 84, and the user interface board 78 may be coupled with the PCB 67 via a user interface wire 86. It is noted that the motor 17 occupies a significant portion of the interior of the body 12 and various other components, such as the spindle lock assembly, are tightly packed within the body 12. Accordingly, the wiring is strategically arranged to be routed through the tight spaces between the motor 17 and other components within the body 12.

For example, because the motor 17 is positioned between the light source 60 and the PCB 67, the light source wire 80 must extend axially across the motor 17 to couple the light source 60 to the PCB 67. The light source wire 80 may be routed along the top side 39 of the interior of the body 12 from the light source 60 to the PCB 67. More particularly, the light source wire 80 is routed around a top of the motor 17, around the screw boss 20, and between the bearing pocket 59 and the power actuator housing 41 until the light source wire 80 terminates at the PCB 67. Additionally, the light source wire 80 is routed from the light source 60 around the spindle lock assembly before extending over the top of the motor 17. A retention feature may be used to hold the light source wire 80 in place.

The motor wires 82 may be routed from along a bottom end 88 of the interior of the body 12 from the motor 17 to the PCB 67. More particularly, the motor wires 82 may be routed around a bottom of the screw boss 20 until the motor wires 82 terminate at the PCB 67. In some embodiments, the light source wire 80 extends around the outside (i.e., radially outward) of a first boss 20a, and the motor wires 82 extend around the outside of a second boss 20b.

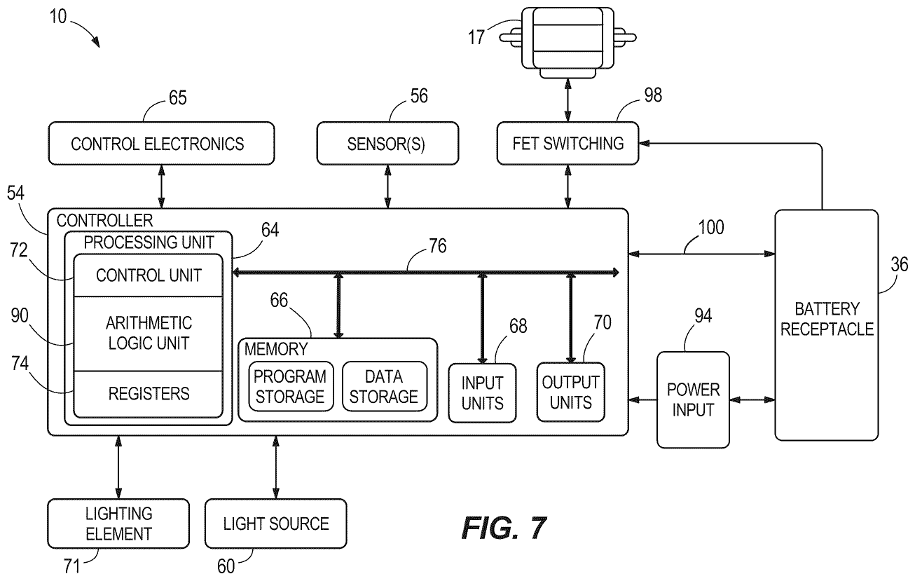

With reference to FIG. 7, the operation of the rotary tool 10 is controlled, monitored, and regulated using control electronics 65 within the rotary tool 10 and within the battery. For example, the controller 54 associated with the control electronics 65. The controller 54 is electrically and/or communicatively connected to a variety of modules or components of the rotary tool 10. For example, the illustrated controller 54 is connected to the user interface 33, one or more sensors 56 including the magnetic sensor 37, the motor 17, the battery, the light source 60, the lighting element 71, the PCB 67, and the user interface board 78. The controller 54 includes combinations of hardware and software that are operable to, among other things, control the operation of the rotary tool 10, activate the speed display 46 (e.g., including one or more LEDs), monitor the operation of the battery pack, etc. The one or more sensors 56 may also include, among other things, one or more temperature sensors, one or more voltage sensors, one or more current sensors, etc. The controller 54 also includes a variety of preset or calculated fault condition values related to temperatures, currents, voltages, etc., associated with the operation of the hand-held power tool.

In some embodiments, the controller 54 includes a plurality of electrical and electronic components that provide power, operational control, and protection to the components and modules within the controller 54 and/or rotary tool 10. For example, the controller 54 includes, among other things, a processing unit 64 (e.g., a microprocessor, a microcontroller, or another suitable programmable device), a memory 66, input units 68, and output units 70. The processing unit 64 includes, among other things, a control unit 72, an arithmetic logic unit (“ALU”) 90, and a plurality of registers 74, and is implemented using a known computer architecture, such as a modified Harvard architecture, a von Neumann architecture, etc. The processing unit 64, the memory 66, the input units 68, and the output units 70, as well as the various modules connected to the controller 54 are connected by one or more control and/or data buses (e.g., common bus 76). The use of one or more control and/or data buses for the interconnection between and communication among the various modules and components would be known to a person skilled in the art in view of the invention described herein. In some embodiments, the controller 54 is implemented partially or entirely on a semiconductor (e.g., a field-programmable gate array [“FPGA”] semiconductor) chip, such as a chip developed through a register transfer level (“RTL”) design process.

The memory 66 includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 64 is connected to the memory 66 and executes software instructions that are capable of being stored in a RAM of the memory 66 (e.g., during execution), a ROM of the memory 66 (e.g., on a generally permanent basis), or another non-transitory computer readable medium such as another memory or a disc. Software included in the implementation of the rotary tool 10 can be stored in the memory 66 of the controller 54. The software includes, for example, firmware, one or more applications, program data, filters, rules, one or more program modules, and other executable instructions. The controller 54 is configured to retrieve from memory and execute, among other things, instructions related to the control of the rotary tool 10 described herein. The controller 54 can also store various rotary tool parameters and characteristics (including battery pack nominal voltage, chemistry, battery cell characteristics, maximum allowed discharge current, maximum allowed temperature, etc.). In other constructions, the controller 54 includes additional, fewer, or different components.

Although the invention has been described in detail with reference to certain preferred embodiments, variations and modifications exist within the scope and spirit of one or more independent aspects of the invention as described. Various features and advantages of the invention are set forth in the following claims.

What is claimed is

1. A rotary tool comprising:
a housing having a first end and a second end;
a motor disposed within the housing, the motor including a drive shaft rotatably driven by the motor and defining a motor axis;
a bit holder positioned adjacent a distal end of the housing and driven by rotation of the drive shaft;
a light source positioned on the first end of the housing, the light source configured to emit light in a direction toward the bit holder;
control electronics disposed adjacent to the motor within the housing, the control electronics including a printed circuit board defining a control electronics axis that is oblique to the motor axis; and
a light source wire electrically coupling the light source with the control electronics;
a motor wire coupling the motor to the printed circuit board, the motor wire extending along a bottom end of an interior of the housing,
wherein the motor is positioned between the light source and the control electronics such that the light source wire extends axially across the motor along a top side of the interior of the housing to couple the light source with the control electronics.

2. The rotary tool of claim 1, wherein the light source is positioned within a retention recess disposed on the first end.

3. (canceled)

4. The rotary tool of claim 1, wherein the light source wire extends around the outside of a first boss, and wherein the motor wire extends around the outside of a second boss.

5. The rotary tool of claim 4, further comprising a variable speed control actuator configured to adjust a rotational speed of the motor, wherein the variable speed control actuator is operable to adjust the speed of the motor between 27,500 RPM and 5,000 RPM.

6. The rotary tool of claim 4, wherein the variable speed control actuator includes twelve speed settings.

7. The rotary tool of claim 4, wherein the user interface includes a speed display configured to indicate a speed level set by the variable speed control actuator.

8. A rotary tool comprising:
a housing having a first end and a second end;
a motor disposed within the housing, the motor including a drive shaft rotatably driven by the motor and defining a motor axis;
a spindle positioned within the housing and extending along the motor axis, the spindle driven by the drive shaft of the motor;
a bit holder positioned adjacent a distal end of the housing and driven by rotation of the drive shaft;
a spindle lock assembly positioned between the motor and the first end of the housing, the spindle lock assembly configured to selective prevent rotation of the spindle;
a light source supported on the first end of the housing and configured to emit light in a direction toward the bit holder;
a printed circuit board (PCB) supported within the housing, the printed circuit board positioned on an opposite side of the motor as the spindle lock; and
a light source wire electrically coupling the light source with the control electronics, wherein the light source wire is routed around the spindle lock assembly and over the top of the motor to couple the light source with the control electronics.

9. The rotary tool of claim 8, further comprising a retention feature holding the light source wire in place at the first end of the housing.

10. The rotary tool of claim 9, wherein the light source wire is further routed around a screw boss in the housing before reaching the printed circuit board.

11. The rotary tool of claim 8, further comprising a battery receptacle supported by the housing, the battery receptacle configured to receive a battery pack that supplies power to the motor.

12. The rotary tool of claim 8, wherein the PCB includes a lighting element mounted to an upper end of the PCB, the lighting element configured to provide information to a user about the operation status of the rotary tool.

13. The rotary tool of claim 8, further comprising a locking structure positioned on the spindle, wherein the spindle lock assembly is configured to engage or disengage from the locking structure to lock and unlock the spindle.

14. The rotary tool of claim 13, wherein the spindle lock assembly is slidably movable relative to the housing to engage with the locking structure and to prevent rotation of the spindle.

15. The rotary tool of claim 8, further comprising a user interface positioned on a top side of the housing, the user interface including a power actuator actuatable to power the motor and a variable speed control actuator configured to adjust a rotational speed of the motor.

16. A rotary tool comprising:
a clamshell housing having a first side and a second side coupled via screws extending through a first screw boss and a second screw boss, the clamshell housing having a first end and a second end;
a motor disposed within the housing, the motor including a drive shaft rotatably driven by the motor and defining a motor axis;
a spindle positioned within the housing and driven by the drive shaft of the motor, the spindle extending through the motor and supported on a first end by a bearing disposed within a bearing pocket;
a bit holder positioned adjacent a distal end of the housing and driven by rotation of the spindle;
a light source positioned on the first end of the clamshell housing and configured to emit light in a direction toward the bit holder;
a printed circuit board (PCB) disposed within the housing;
a light source wire electrically coupling the light source with the printed circuit board, the light source wire routed around the outside of the first screw boss; and
a motor wire coupling the motor to the printed circuit board, the motor wire routed around the outside of the second screw boss.

17. The rotary tool of claim 16, wherein the motor is positioned between the light source and the control electronics such that the light source wire extends axially across the motor along a top side of an interior of the housing to couple the light source with the control electronics.

18. The rotary tool of claim 17, wherein the motor wire extends from the motor to the printed circuit board without passing over the motor.

19. The rotary tool of claim 18, wherein the printed circuit board defines an axis that is oblique to the motor axis.

20. The rotary tool of claim 16, wherein the light source wire is routed from the first end to the second end along a top side of an interior of the housing, around the first screw boss, and between a bearing pocket and a power actuator.
